(19) United States
(12) Patent Application Publication
(10) Pub. No.: US 2009/0176474 A1
(43) Pub. Date: Jul. 9, 2009

(54) APPARATUS, METHOD AND COMPUTER PROGRAM PRODUCT FOR MAINTAINING EMERGENCY CALLS DURING MOBILE DEVICE MOVEMENT

(75) Inventor: Gabor Bajko, Mountain View, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/970,350

(22) Filed: Jan. 7, 2008

(51) Int. Cl. H04M 11/04

(52) U.S. Cl. 455/404.1

(57) ABSTRACT

An apparatus, method and computer program product are provided for maintaining emergency calls during mobile device movement. In order to ensure that an emergency call is not lost despite movement of the mobile device, the mobile device may provide an update of its geographic location, as well as its network address, if it has changed, each time the mobile device performs a handover. In addition, in order to ensure that the mobile device maintains a connection to the same emergency call center throughout the duration of the emergency call, the mobile device may receive an address associated with the emergency call center upon initiating the emergency call. This address can thereafter be transmitted, along with the mobile device's updated location information, so that the connection to the call center associated with that address can be maintained, where possible, regardless of the location of the mobile device.

### FIELD

Embodiments of the invention relate, generally, to emergency calls and, in particular, to the use of a mobile device to place an emergency call.

### BACKGROUND

Being able to place an emergency call from anywhere using nearly any type of electronic device capable of establishing a connection with another device or system (e.g., using a cellular telephone, personal digital assistant (PDA), pager, laptop, tablet, or the like) is rapidly becoming more and more possible and prevalent. This is, in part, as a result of infrastructures being put in place that will enable emergency calls to be placed using Internet, or other network, technologies.

For example, a working group of the Internet Engineering Task Force (IETF), an organization that develops and promotes Internet standards, such as TCP/IP and Internet protocol suites (i.e., the set of communications protocols that implement the protocol stack on which the Internet and many commercial networks run), referred to as the Emergency Context Resolution and Internet Technologies (ECRIT) working group, has established a framework for emergency calling using Internet multimedia. (See Rosen, et al., Framework for Emergency Calling using Internet Multimedia, IETF ECRIT, Internet-Draft, available at http://ietf.org/internet-drafts/draft-ietf-ecrit-framework-04.txt).

Certain logistical issues arise, however, when the party making the emergency call is mobile. As one would expect, an emergency response agency needs to know the most accurate geographic location of the caller in order to dispatch emergency responders. In addition, a call center responsible for receiving the emergency call and dispatching responders from the emergency response agencies likely needs to know the most up-to-date network location of the emergency caller (i.e., how to route the emergency call), so that the call center can re-establish the connection with the emergency caller in the event that the connection is lost.

A need, therefore, exists for a technique for ensuring that the most up-to-date location information associated with an emergency caller is known and made available to the emergency responders.

### BRIEF SUMMARY

In general, embodiments of the present invention provide an improvement by, among other things, providing techniques for ensuring that emergency calls are not dropped after the call has been initiated as a result of movement of the mobile device used to conduct the emergency call. In particular, according to one embodiment, the mobile device may provide an update of its geographic location, as well as its network address, if it has changed, each time the mobile device performs a handover (i.e., changes its physical access point to the communication network being used). In another embodiment, in order to ensure that the mobile device maintains a connection to the same emergency call center (i.e., a call center responsible for accepting emergency calls and dispatching emergency responders) throughout the duration of the emergency call, the mobile device may receive an address associated with the emergency call center upon initiating the emergency call. This address can thereafter be transmitted, along with the mobile device's updated location information, so that the connection to the call center associated with that address can be maintained, where possible, regardless of the location of the mobile device.

In accordance with one aspect, an apparatus is provided for maintaining emergency calls during handover. In one embodiment, the apparatus may include a processor configured to: (1) initiate an emergency call; (2) perform a handover; and (3) transmit an update request comprising a different location in response to performing the handover. In one embodiment, the processor may be further configured to transmit an invitation to an emergency call center and receive a response accepting the invitation that includes an address associated with the emergency call center. According to this embodiment, the update request transmitted may include the address associated with the emergency call center.

In accordance with another aspect, a method is provided for maintaining emergency calls during handover. In one embodiment, the method may include: (1) initiating an emergency call; (2) performing a handover; and (3) transmitting an update request comprising a different location in response to performing the handover.

According to yet another aspect, a computer program product is provided for maintaining emergency calls during handover. The computer program product contains at least one computer-readable storage medium having computer-readable program code portions stored therein. The computer-readable program code portions of one embodiment include: (1) a first executable portion for initiating an emergency call; (2) a second executable portion for performing a handover; and (3) a third executable portion for transmitting an update request comprising a different location in response to performing the handover.

According to one aspect, an apparatus is provided for maintaining emergency calls during handover. In one embodiment, the apparatus may include: (1) means for initiating an emergency call; (2) means for performing a handover; and (3) means for transmitting an update request comprising a different location in response to performing the handover.

In accordance with yet another embodiment, an apparatus is provided for routing emergency calls during handover. In one embodiment, the apparatus may include a processor configured to (1) receive a request to update a location associated with a mobile device, said request including an address associated with an emergency call center; and (2) transmit the request to the address, wherein the apparatus is outside of a boundary associated with the emergency call center.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIGS. 1A-1C are block diagrams of types of systems that would benefit from embodiments of the present invention;

FIG. 2 is a schematic block diagram of an entity capable of operating as a proxy server (e.g., an Emergency Services Routing Proxy) in accordance with embodiments of the present invention;

FIG. 3 is a schematic block diagram of a mobile station capable of operating in accordance with an embodiment of the present invention; and

FIGS. 4 and 5 are a signal flow diagrams illustrating the process of maintaining an authenticated or an unauthenticated emergency call during mobile device movement in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for maintaining emergency calls placed by a mobile device using a communication network, such as the Internet. According to one embodiment, in order to place the emergency call, the mobile device may establish a connection with an emergency call center established by response agencies and responsible for receiving emergency calls and dispatching emergency responders. The connection may be established via an access network and a proxy server, or similar communication device, responsible for routing emergency calls to appropriate emergency call centers based primarily on the location of the mobile device.

In order to ensure that the emergency call is maintained despite movement of the mobile device, according to one embodiment of the present invention, the mobile device may provide an update of its geographic and, if necessary, network location each time the mobile device performs a handover resulting, for example, in a change in the access network and/or the proxy server to which the mobile device is connected, and, in some instances, the mobile device moving outside of a boundary associated with the emergency call center. In another embodiment, in order to ensure that the mobile device maintains a connection to the same emergency call center throughout the duration of the emergency call, even if it has moved outside of the emergency call center's boundary, the mobile device may receive an address associated with the emergency call center upon initiating the emergency call and thereafter transmit this address, along with the mobile device's updated location information.

### Overall System and Mobile Device:

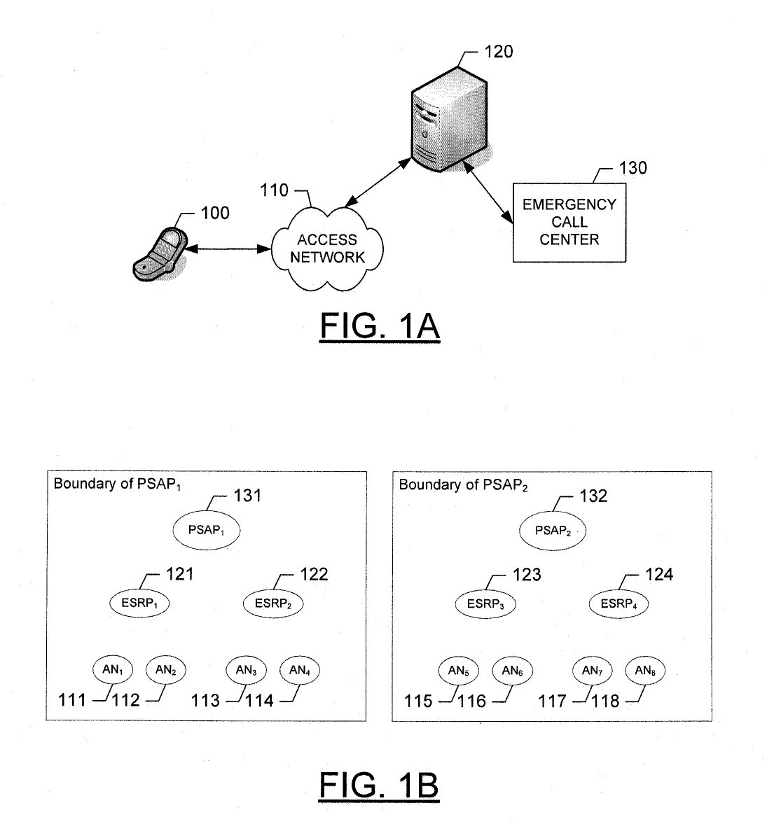

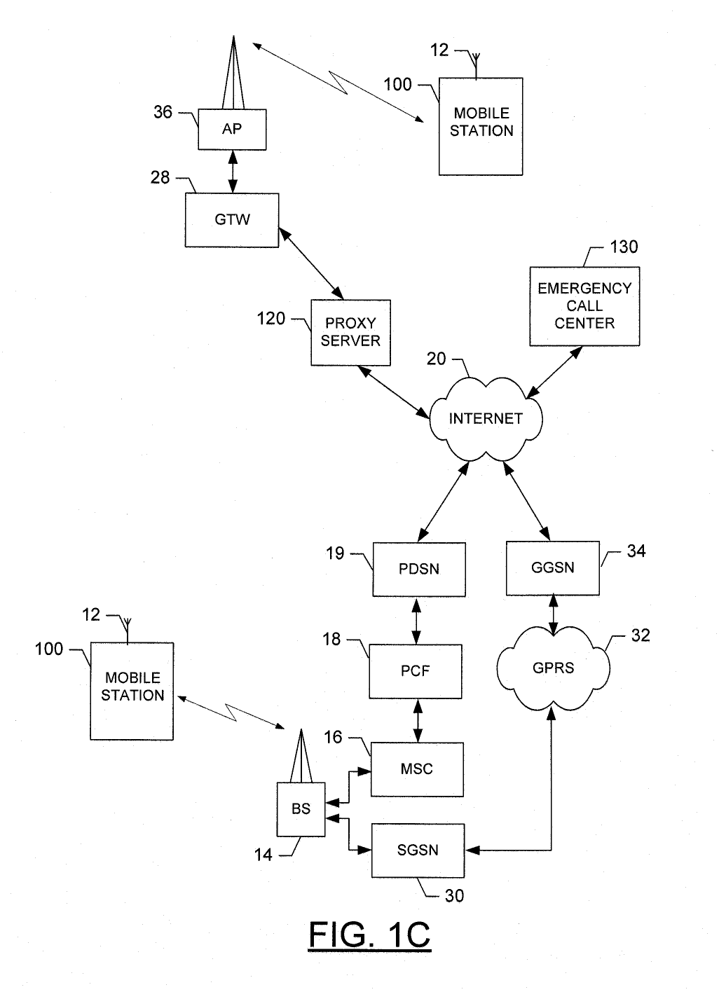

Referring to FIG. 1A, an illustration of one type of system that would benefit from embodiments of the present invention is provided. As shown, the system may include one or more mobile devices 100 (e.g., cellular telephones, personal digital assistants (PDAs), laptops, pagers, tablets, etc.) capable of establishing a connection with an access network 110. The access network 110 may be any communication network capable of providing packet services to the mobile device. This may include, for example, a Digital Subscriber Line (DSL) or cable modem, WiMAX (IEEE 802.16) service, a WiFi network (IEEE 802.11b) and/or any mobile (cellular) data network, such as a local area network (LAN), a metropolitan area network (MAN), and/or a wide area network (WAN).

The system may further include one or more emergency call centers 130 established by emergency response agencies to accept emergency calls from a mobile device 100 and to dispatch emergency responders. One or more proxy servers 120, or similar communication devices, may further be included in order to route the emergency calls to the appropriate emergency call center, primarily based on the location of the mobile device 100. While referred to hereinafter as a proxy “server,” as one of ordinary skill in the art will recognize, embodiments of the present invention are not limited to a client-server architecture.

As shown in FIG. 1B, one embodiment of the present invention may be implemented in association with the emergency call framework established by the IETF ECRIT working group, discussed above. In particular, the emergency call center 130 of FIG. 1A may correspond to a Public Safety Answering Points (PSAPs) 131, 132 provided by the ECRIT working group. As shown in FIG. 1B, each PSAP 131, 132 may have a geographic boundary associated therewith, wherein, whenever possible, emergency calls received from a mobile device operating within a boundary associated with a PSAP 131, 132 are routed to that PSAP 131, 132. This, of course, may depend on the state of the PSAP, for example, in terms of the capacity of the PSAP, the volume of calls the PSAP is currently handling, and/or the like.

In addition, the proxy server 120 of FIG. 1A may correspond to an Emergency Services Routing Proxy (ESRP) 121, 122, 123 and 124 provided by the IETF ECRIT working group framework. As shown, each PSAP 131, 132 may have one or more ESRPs 121, 122, 123 and 124 configured to route emergency calls to that PSAP 131, 132 where possible and appropriate. For example, ESRP₁ 121 and ESRP₂ 122 may primarily route emergency calls received to PSAP₁ 131, while ESRP₃ 123 and ESRP₄ 124 may primarily route emergency calls received to PSAP₂ 132.

In addition, each ESRP 121, 122, 123 and 124 may have one or more access networks 111, 112, 113, 114, 115, 116, 117 and 118 associated therewith, such that emergency calls received by an access network 111, 112, 113, 114, 115, 116, 117 and 118 may be routed to the ESRP 121, 122, 123 and 124 with which the access network is connected.

Referring now to FIG. 1C, a further illustration of one type of system that would benefit from embodiments of the present invention is provided. As shown in FIG. 1C, the system can include one or more mobile stations 100, each having an antenna 12 for transmitting signals to and for receiving signals from one or more base stations (BS's) 14. The base station is a part of one or more cellular or mobile networks (e.g., one of the access networks 111, 112, 113, 114, 115, 116, 117 and 118 described above) that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 100 via the Internet. For example, the processing elements can include the proxy server 120, or similar computing device, used to route emergency calls to an emergency call center 130, also included in FIG. 1C. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 100 may be coupled to one or more of any of a number of different networks. In this regard, mobile network(s) can be capable of supporting communication in accordance with any one or more of a number of first-generation (1G), second-generation (2G), 2.5 G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5 G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 100 (as well as one or more processing elements, although not shown as such in FIG. 1C) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including Wireless LAN (WLAN) techniques. The APs may be coupled to the Internet 20. Like with the MSC 16, the AP's can be directly coupled to the Internet. In one embodiment, however, the APs are indirectly coupled to the Internet via a GTW 28 and, in one embodiment shown, the proxy server 120. As will be appreciated, by directly or indirectly connecting the mobile stations and the processing elements (e.g., proxy server 120 and/or emergency call center 130) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1C, in addition to or in lieu of coupling the mobile stations 100 to one or more processing elements (e.g., proxy server 120 and/or emergency call center 130) across the Internet 20, one or more such entities may be directly coupled to one another. As such, one or more network entities may communicate with one another in accordance with, for example, RF, BT, IrDA or any of a number of different wireline or wireless communication techniques, including LAN and/or Wireless LAN techniques. Further, the mobile station 10 and the processing elements can be coupled to one or more electronic devices, such as printers, digital projectors and/or other multimedia capturing, producing and/or storing devices (e.g., other terminals).

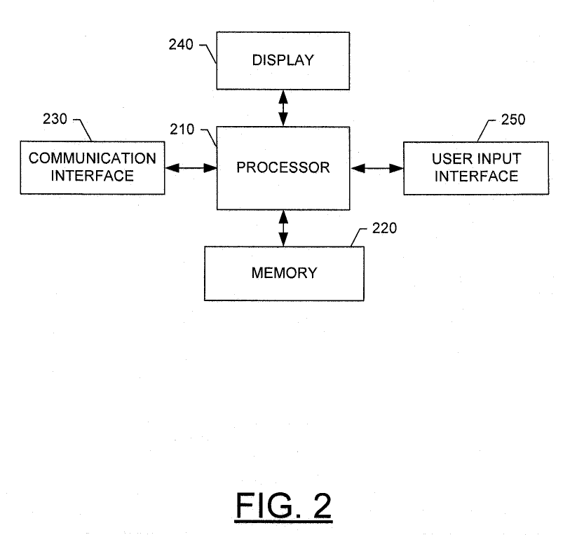

Referring now to FIG. 2, a block diagram of an entity capable of operating as a proxy server 120 is shown in accordance with one embodiment of the present invention. The entity capable of operating as a proxy server 120 includes various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as a proxy server 120 can generally include means, such as a processor 210 for performing or controlling the various functions of the entity.

In particular, according to one embodiment, the processor 210 may be configured to receive an invitation for an emergency call from a mobile device and to route the emergency call to an emergency call center based at least in part on the physical location (e.g., geolocation) of the mobile device. The processor 210 may further be configured to receive a request to update the location associated with a mobile device with which an emergency call has previously been initiated, wherein the request includes an address associated with the emergency call center with which the call was initiated. The processor 210 may thereafter be configured to transmit the request to the address included, regardless of whether the proxy server 120 resides outside of a boundary associated with the emergency call center corresponding to that address.

In one embodiment, the processor is in communication with or includes memory 220, such as volatile and/or non-volatile memory that stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention. For example, the memory may store software instructions for the processor 210 to perform the steps described above with regard to receiving and routing an emergency call, and receiving and transmitting a request to update a mobile device location in association with a previously initiated emergency call.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

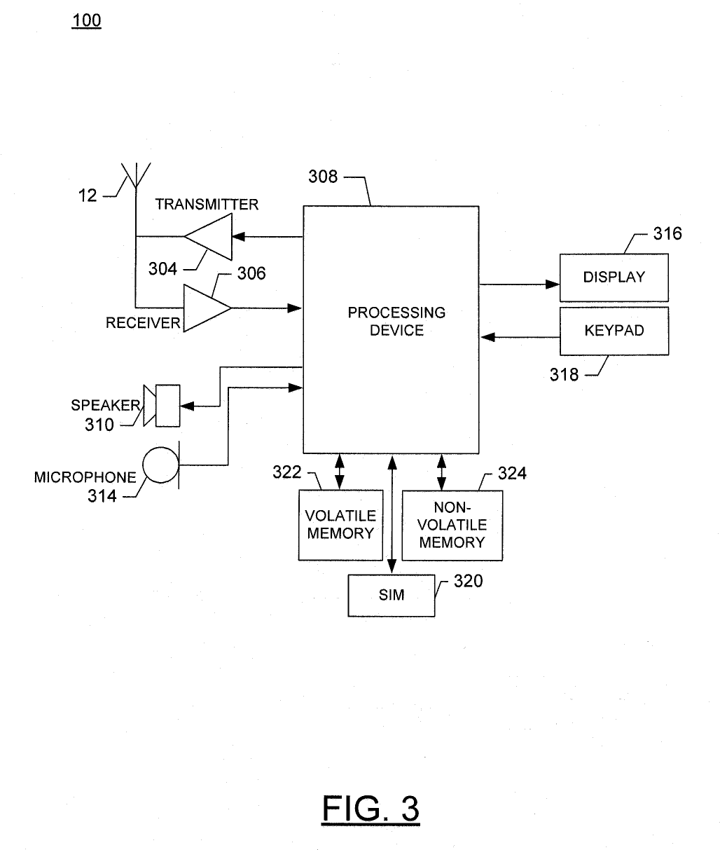

Reference is now made to FIG. 3, which illustrates one type of electronic device that would benefit from embodiments of the present invention. As shown, the electronic device may be a mobile station 100, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 3, in addition to an antenna 302, the mobile station 100 includes a transmitter 304, a receiver 306, and an apparatus that includes means, such as a processing device 308, e.g., a processor, controller or the like, that provides signals to and receives signals from the transmitter 304 and receiver 306, respectively, and that performs the various other functions described below including, for example, the functions relating to maintaining an emergency call despite movement of the mobile station 100.

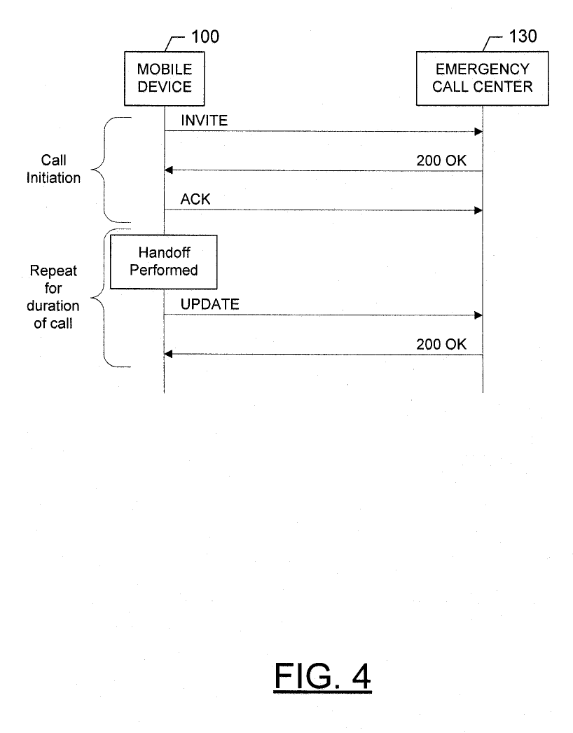

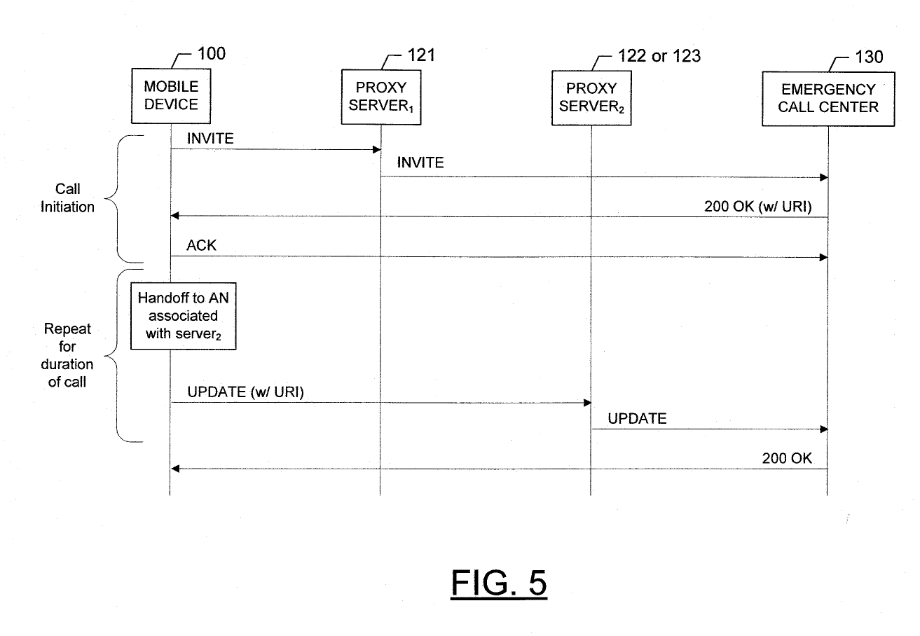

As discussed in more detail below with regard to FIGS. 4 and 5, in one embodiment, the processor 308 may be configured to initiate an emergency call by transmitting an invitation to an emergency call center and receiving a response from the emergency call center accepting the invitation, wherein the response includes an address associated with the emergency call center. The processor 308 may thereafter be configured to perform a handover and, in response to performing the handover, transmit an update request including a different location associated with the mobile station 100. In one embodiment, the update request may further include the address associated with the emergency call center with which the emergency call was initiated.

As one of ordinary skill in the art would recognize, the signals provided to and received from the transmitter 304 and receiver 306, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5 G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a microphone 314 and a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. The memory may, for example, store computer program code for an application and other computer programs. For example, in one embodiment of the present invention, the memory may store computer program code for ensuring that an emergency call is not dropped despite movement of the mobile station 100. In particular, according to one embodiment, the memory 322 may store computing program code for initiating an emergency call by transmitting an invitation to an emergency call center and receiving a response from the emergency call center accepting the invitation, wherein the response includes an address associated with the emergency call center. The memory 322 may further store computer program code for performing a handover and, in response to performing the handover, transmitting an update request including a different location associated with the mobile station 100. In one embodiment, the update request may further include the address associated with the emergency call center with which the emergency call was initiated.

### Method of Ensuring an Authenticated Emergency Call is Maintained

Reference is now made to FIG. 4, which provides a signal flow diagram associated with the initiation and maintenance of an authenticated emergency call despite movement of a mobile device in accordance with embodiments of the present invention. As one of ordinary skill in the art will recognize, an authenticated emergency call refers to an emergency call placed by a mobile device having a network subscription. Based on the subscription, the access network, proxy server and emergency call center know the identity of the mobile device from which the emergency call is received. As a result, the proxy server and emergency call center used to place these calls are largely hidden from the mobile device. In other words, the specific addressing and routing associated with placement of the emergency call are largely transparent to the mobile device. In light of this, FIG. 4 illustrates what the mobile device experiences and not the details of how the messages are relayed and routed by the access network and proxy server, which are shown in more detail in FIG. 5, discussed below.

In general, the process may begin when the mobile device and, in particular, a processor or similar means operating on the mobile device, initiates an emergency call with the emergency call center (e.g., PSAP). As shown, this may be done by transmitting a Session Initiation Protocol (SIP) INVITE message to the emergency call center. As one of ordinary skill in the art will recognize, SIP is an application-layer control (signaling) protocol for creating, modifying and terminating sessions with one or more participants that is designed to be independent of the underlying transport layer (i.e., it can run on Transmission Control Protocol (TCP), User Datagram Protocol (UDP), Stream Control Transmission Protocol (SCTP), etc.). While use of SIP as the signaling protocol may be beneficial given this ubiquitous quality, as one of ordinary skill in the art will recognize, other inter-domain signaling protocols, such as H.323, Extensible Messaging and Presence Protocol (XMPP)/Jingle, ISUP (ISDN Signaling User Part), and the like, may likewise be used for establishing the connection between the mobile device and the emergency call center. As a result, while the signaling described herein uses SIP messaging, embodiments of the present invention are not limited to this particular signaling protocol.

In one embodiment, the SIP INVITE may include a geolocation header including a geographic location associated with the mobile device. This geographic location may be used (e.g., by a proxy server) to select the most appropriate emergency call center for receiving the call and dispatching the emergency responders. The mobile device may have obtained its geographic location from any number of sources including, for example, a Global Positioning System (GPS) receiver associated with the mobile device, a location server (e.g., Dynamic Host Configuration Protocol (DHCP) server, Link Layer Discovery Protocol (LLDP) server, etc.), or the like. Upon receipt of the SIP INVITE, the emergency call center may respond with an acceptance message (e.g., SIP 200 OK), in response to which the mobile device (e.g., processor or similar means operating on the mobile device) may transmit an acknowledgment message (e.g., SIP ACK). At this point the emergency call may be established between the mobile device and the emergency call center.

Assuming the emergency caller is moving at the time he or she is placing the emergency call, at some point the emergency caller's mobile device may need to handover to a different physical access point to the communication network being used. In one embodiment, this movement may involve only a change in the mobile device's geographic location, and not a change in the network address (e.g., IP address) associated with the mobile device. This may occur when the handover is, for example, within an IEEE 802.11 Mobility Domain, between cells of the same access network, or the like. In another embodiment, the movement may result in a change in both the mobile device's geographic location and its network address; however, the mobile device may be reachable at its previous network address (e.g., if the mobile device has a mobile IP stack). In either of these embodiments, following handoff, the mobile device and, in particular, the processor or similar means operating on the mobile device, may transmit an update request (e.g., a SIP UPDATE) to the emergency call center that includes the new (or different) geographic location associated with the mobile device (e.g., in the geolocation header of the SIP UPDATE). In response, the emergency call center may transmit an acceptance signal (e.g., SIP 200 OK) to notify the mobile device that it has received the updated request.

In yet another embodiment, the handover performed by the mobile device may result in a change in the network address (e.g., IP address) associated with the mobile device, wherein the mobile device is no longer reachable at its previous network address (e.g., if the mobile device does not have a mobile IP stack). In this embodiment, in addition to including the new (or different) geographic location in the update request (e.g., in the geolocation header of the SIP UPDATE message), the mobile device (e.g., processor or similar means operating on the mobile device) may include the new (or different) network address (e.g., IP address) in the update request (e.g., in the contact header of the SIP UPDATE message).

In each of the above embodiments, dual anchoring may be used if Mobile IP (MIP) is used. In other words, the mobile device (e.g., processor or similar means) may register with the registrar of the Home Address (HoA) and transmit the current Care of Address (CoA) in the invitation (e.g., in the contact header of the SIP INVITE message) and the update request (e.g., in the contact header of the SIP UPDATE). This type of dual anchoring ensures that the call initiator can be called back on its HoA, while it may be using its CoA to place calls.

By updating the geographic location and network address each time the mobile device (e.g., processor or similar means operating on the mobile device) performs a handover, embodiments of the present invention ensure that, where possible, the emergency call center has up-to-date location information. Using the updated information, the emergency call center should know how to route the emergency call to the mobile device in the event that the emergency call is lost, as well as the most accurate geographic location to which to dispatch the emergency responders.

### Method of Ensuring an Unauthenticated Emergency Call is Maintained

A method of ensuring that an unauthenticated emergency call is maintained despite movement of a mobile device in accordance with an embodiment of the present invention will now be described with reference to FIG. 5, which provides a signal flow diagram associated with initiating and maintaining the emergency call. As one of ordinary skill in the art will recognize, in contrast to the scenario described above with regard to FIG. 4, an unauthenticated emergency call refers to an emergency call placed by a mobile device that does not have a network subscription. Such a call may be placed, for example, using the extended architecture provided by the IETF ECRIT working group. (See Schulzrinne, et al. Extensions to the Emergency Services Architecture for dealing with Unauthenticated and Unauthorized Devices, IETF ECRIT, Internet-Draft, available at www.ietf.org/internet-drafts/draft-schulzrinne-ecrit-unauthenticated-access-01.txt). Unlike the above, when making an unauthenticated emergency call, the mobile device is aware of and must go through a proxy server (e.g., ESRP). In other words, the details of the relaying and routing involved in unauthenticated emergency calls are not transparent to the mobile device. As a result, while FIGS. 4 and 5 may be applicable for both authenticated and unauthenticated emergency calls, additional routing and signaling details are provided in FIG. 5 for the below discussion.

As above with regard to authenticated emergency calls, the process may begin when the mobile device and, in particular, a processor or similar means operating on the mobile device initiates an emergency call with an emergency call center (e.g., referring to FIG. 1B, PSAP₁ 131). In particular, the mobile device (e.g., processor or similar means) may transmit an invitation to an emergency call (e.g., a SIP INVITE message) via an access network (e.g., AN₁ 111) to a proxy server (e.g., ESRP₁ 121) associated with that access network, wherein the invitation may include a geographic location associated with the mobile device (e.g., in a geolocation header of the SIP INVITE message). The proxy server (e.g., ESRP₁ 121) may then route the invitation to the most appropriate emergency call center (e.g., PSAP₁ 131) based primarily on the location of the mobile device or of the proxy server itself (e.g., if the location of the mobile device is not included in the SIP INVITE, or similar, message). As one of ordinary skill in the art will recognize, other factors may go into the decision of to which emergency call center to route the emergency call including, for example, the volume of calls being handled by respective emergency call centers, the bandwidth of each call center, and the like.

Upon receipt of the invitation (e.g., SIP INVITE message), the emergency call center (e.g., PSAP₁ 131) may respond, as described above, with an acceptance message (e.g., SIP 200 OK message). In this embodiment, however, the emergency call center may include in the acceptance message an address (e.g., a uniform resource identifier (URI)) associated with the emergency call center (e.g., PSAP₁ 131). For example, the address may be included in the contact header of a SIP 200 OK message. In response, the mobile device (e.g., processor or similar means operating on the mobile device) may transmit an acknowledgement message (e.g., SIP ACK message). At this point the emergency call may be established between the mobile device and the emergency call center (e.g., PSAP₁ 131) selected by the proxy server (e.g., ESRP, 121).

At some point thereafter, the mobile device (e.g., processor or similar means) may handoff to a different physical access point to the communication network used for the emergency call. As described above with reference to FIG. 1B, each emergency call center may have one or more proxy servers with which it is associated. Similarly, each proxy server may be accessed by one or more access networks. In one embodiment, handoff by the mobile device may result in a change of the access network used by the mobile device, but not the proxy server. For example, referring to FIG. 1B, the handoff may result in a change from AN₁ 111 to AN₂ 112, both of which are associated with ESRP₁ 121 and within the boundary of PSAP₁ 131. Alternatively, in another embodiment, the handoff may result in change in both the access network used as well as the proxy server, but not a movement outside of the boundary ordinarily associated with the original emergency call center. For example, the handoff may result in a change from AN₁ 111 to AN₃ 113 and, therefore, a change from ESRP₁ 121 to ESRP₂ 122, both of which are within the boundary of PSAP₁ 131. In yet another embodiment, the handoff may further result in a movement outside of the boundary associated with the original emergency call center. For example, the handoff may result in a change from AN₁ 111 to AN₅ 115 and, therefore, a change from ESRP₁ 121 to ESRP₃ 123 and a movement from the boundary associated with PSAP₁ 131 to the boundary associated with PSAP₂ 132.

According to embodiments of the present invention, regardless of which of the above scenarios occurs, using the address included in the acceptance message (e.g., SIP 200 OK message) received from the emergency call center during call initiation, the mobile device (e.g., processor or similar means operating on the mobile device) can ensure that the emergency call is maintained with the original emergency call center, where possible, throughout the duration of the call.

In particular, according to one embodiment of the present invention, when the mobile device performs a handover, the mobile device (e.g., processor or similar means) may transmit an update request (e.g., SIP UPDATE message) including its new (or different) geographic location (e.g., in the geolocation header of the SIP UPDATE message), as well as its new (or different) network address (e.g., in the contact header of the SIP UPDATE message), where applicable. The mobile device (e.g., processor or similar means operating on the mobile device) may further include the address (e.g., URI) of the emergency call center (e.g., PSAP₁ 131) with which the emergency call was initiated (e.g., in the route header of the SIP UPDATE message). In addition, according to one embodiment, the mobile device may also include the address of the proxy server (e.g., ESRP₁ 121) responsible for initially receiving and routing the emergency call (e.g., as the topmost Route header of the SIP UPDATE message).

Where the handover resulted in a change in the proxy server (e.g., from ESRP₁ 121 to ESRP₂ 122 or ESRP₃ 123), the mobile device (e.g., processor or similar means) may transmit the update request to the new (or different) proxy server (e.g., to ESRP₂ 122 or ESRP₃ 123). Upon receipt, the proxy server (e.g., to ESRP₂ 122 or ESRP₃ 123) may recognize that the update request is associated with an emergency call with which it was not previously associated (i.e., for which it did not receive and route the call initiation messaging). The proxy server (e.g., ESRP₂ 122 or ESRP₃ 123) may then use the address (e.g., URI) included in the update request to route the update request to the emergency call center with which the emergency call was originally initiated (e.g., PSAP₁ 131). The proxy server (e.g., ESRP₂ 122 or ESRP₃ 123) may further route the update request via the original proxy server (e.g., ESRP₁ 121) using the address included in the update request. In this embodiment, the route may, therefore, be from the receiving proxy server (e.g., ESRP₂ 122 or ESRP₃ 123) to the original proxy server (e.g., ESRP₁ 121) and finally to the original emergency call center (e.g., PSAP₁ 131). In one embodiment, the proxy server may route the emergency call to the original emergency call center despite the fact that the proxy server is not within the boundary associated with the original emergency call center. For example, ESRP₃ 123 may route the update request to PSAP₁ 131, even though ESRP₃ 123 is within the boundary of PSAP₂ 132, and not PSAP₁131.

Based on the foregoing, the emergency call center with which the emergency call was originally initiated may be provided with updated geographic and network location information each time the mobile device hands off to a different physical access point. In addition, the new (or different) proxy server may be notified to let the emergency call through.

As described above, the overall process of maintaining an emergency call may be more difficult where the access network to which the mobile device is routed during handover is associated with a different proxy server than the one involved in the initial call establishment (e.g., from AN₁ 111 associated with ESRP₁ 121 to AN₃ 113 associated with ESRP₂ 122). As one of ordinary skill in the art will recognize, however, when a mobile device is performing a handover, the mobile device may have the possibility of selecting between a number of different access networks. According to one embodiment, in order to alleviate the difficulty associated with maintaining the emergency call during movement of the mobile device, the mobile device (e.g., processor or similar means operating on the mobile device) may attempt to select an access network that it associated with the same proxy server as that with which the original access network was associated.

In particular, embodiments of the present invention provide two techniques that may be used in order to select an access network associated with a particular proxy server. In one embodiment, the mobile device (e.g., processor or similar means operating on the mobile device) may look for an access network having the same Service Set Identifier (SSID), Extended SSID (ESSID) and/or Homogeneous ESSID (HESSID) as that of the one to which the mobile device is currently connected. This may ensure that the mobile device remains within the same Extended Service Set (ESS) and, therefore, more likely to be within the reach of the same proxy server.

According to another embodiment, which may be used, for example, if an access network within the same SSID is not available, information identifying the proxy server associated with various access networks may be made available to the mobile device, such that the mobile device (e.g., processor or similar means) may specifically select the access network associated with the desired proxy server. In one embodiment, a mapping of access network to proxy servers may be maintained, for example, in a network database accessible by the mobile device. Alternatively, or in addition, the mobile device (e.g., processor or similar means) may be configured to query a proxy server to which it has not been authenticated in order to request the identity of the proxy server with which it is associated (e.g., using a GAS Native query of 802.11u, or by defining a new field of the existing “Native Info Emergency Public Network Access Element,” See IEEE P802.11u™/D1.0, Draft Standard for Information Technology—Telecommunications and Information Exchange between systems—Local and metropolitan area networks—Specific Requirements—Part 11: Wireless Medium Access Control (MAC) and Physical layer (PHY) specifications: Amendment: Enhancements for Interworking with External Networks, May 2007). In this embodiment, the mobile device may query the potential access networks until it locates one associated with the desired access network.

### Conclusion:

As described above and as will be appreciated by one skilled in the art, embodiments of the present invention may be configured as an apparatus or method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 210 discussed above with reference to FIG. 2 or processing device 308 discussed above with regard to FIG. 3, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 210 of FIG. 2 and/or processing device 308 of FIG. 3) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
initiate an emergency call;
perform a handover; and
transmit an update request comprising a different location in response to performing the handover.

2. The apparatus of claim 1, wherein the update request further comprises a different network address.

3. The apparatus of claim 1, wherein in order to transmit the update request, the processor is further configured to transmit a Session Initiation Protocol update request comprising a geolocation header, said geolocation header comprising the different location.

4. The apparatus of claim 2, wherein in order to transmit the update request, the processor is further configured to transmit a Session Initiation Protocol update request comprising a geolocation header and a contact header, said geolocation header comprising the different location and said contact header comprising the different network address.

5. The apparatus of claim 1, wherein in order to initiate an emergency call, the processor is further configured to:
transmit an invitation to an emergency call center; and
receive a response accepting the invitation, said response including an address associated with the emergency call center.

6. The apparatus of claim 5, wherein the update request further comprises the address associated with the emergency call center.

7. The apparatus of claim 6, wherein in order to transmit the invitation to an emergency call center, the processor is further configured to transmit the invitation via a computing device associated with the emergency call center, and wherein the update request further comprises an address associated with the computing device.

8. The apparatus of claim 6, wherein in order to transmit the update request, the processor is further configured to transmit a Session Initiation Protocol update request comprising a route header, said route header including the address associated with the emergency call center.

9. The apparatus of claim 6, wherein in order to transmit the update request, the processor is further configured to transmit the update request via one of a plurality of access networks associated with a computing device in communication with the emergency call center.

10. The apparatus of claim 9, wherein the computing device is outside of a boundary associated with the emergency call center.

11. The apparatus of claim 9, wherein the processor is further configured to:
select an access network with which to transmit the update request based at least in part on the computing device with which the selected access network is associated.

12. The apparatus of claim 11, wherein in order to transmit the invitation to an emergency call center, the processor is further configured to transmit the invitation via a first access network associated with an extended service set, and wherein in order to select an access network with which to transmit the update request, the processor is further configured to select an access network associated with the extended service set.

13. The apparatus of claim 11, wherein in order to transmit the invitation to an emergency call center, the processor is further configured to transmit the invitation via an access network associated with a first computing device in communication with the emergency call center, and wherein in order to select an access network with which to transmit the update request, the processor is further configured to access a database comprising an indication of the plurality of access networks associated with respective computing devices in order to select an access network associated with the first computing device.

14. A method comprising:
initiating an emergency call;
performing a handover; and
transmitting an update request comprising a different location in response to performing the handover.

15. The method of claim 14, wherein the update request further comprises a different network address.

16. The method of claim 14 further comprising:
transmitting an invitation to an emergency call center; and
receiving a response accepting the invitation, said response including an address associated with the emergency call center.

17. The method of claim 16, wherein the update request further comprises the address associated with the emergency call center.

18. The method of claim 17, wherein transmitting the update request further comprises transmitting the update request via one of a plurality of access networks associated with a computing device in communication with the emergency call center.

19. The method of claim 18, wherein the computing device is outside of a boundary associated with the emergency call center.

20. The method of claim 18 further comprising:
selecting an access network with which to transmit the update request based at least in part on the computing device with which the selected access network is associated.

21. A computer program product comprising at least one computer-readable storage medium having computer-readable program code portions stored therein, the computer-readable program code portions comprising:
a first executable portion for initiating an emergency call;
a second executable portion for performing a handover; and
a third executable portion for transmitting an update request comprising a different location in response to performing the handover.

22. The computer program product of claim 21, wherein the update request further comprises a different network address.

23. The computer program product of claim 21, wherein the computer-readable program code portions further comprise:
a fourth executable portion for transmitting an invitation to an emergency call center; and
a fifth executable portion for receiving a response accepting the invitation, said response including an address associated with the emergency call center.

24. The computer program product of claim 23, wherein the update request further comprises the address associated with the emergency call center.

25. The computer program product of claim 24, wherein the third executable portion is configured to transmit the update request via one of a plurality of access networks associated with a computing device in communication with the emergency call center.

26. The computer program product of claim 25, wherein the computer-readable program code portions further comprise:
a sixth executable portion for selecting an access network with which to transmit the update request based at least in part on the computing device with which the selected access network is associated.

27. An apparatus comprising:
means for initiating an emergency call;
means for performing a handover; and
means for transmitting an update request comprising a new location in response to performing the handover.

28. An apparatus comprising:
a processor configured to:
receive a request to update a location associated with a mobile device, said request including an address associated with an emergency call center; and
transmit the request to the address, wherein the apparatus is outside of a boundary associated with the emergency call center.
